(19) United States
(12) Patent Application Publication
(10) Pub. No.: US 2010/0032421 A1
(43) Pub. Date: Feb. 11, 2010

(54) FLAT ELECTRIC HEATER ELEMENT, IN PARTICULAR FOR GLASS PANES OF A MOTOR VEHICLE

(75) Inventors: Jose A. Martinez, Franklin Park, IL (US); Erik Arnold, Gorxheimertal (DE)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ILLINOIS TOOL WORKS INC., Glenview, IL (US)

(21) Appl. No.: 12/519,375

(22) PCT Filed: Aug. 31, 2007
(86) PCT No.: PCT/EP2007/059085

§ 371 Date: Jun. 16, 2009

Related U.S. Application Data
(60) Provisional application No. 60/876,179, filed on Dec. 20, 2006.

(51) Int. Cl. H05B 3/84; H05B 3/06; B60L 1/02

(52) U.S. Cl. 219/203; 219/520

(57) ABSTRACT

Flat electric heater element having a self-adhesive surface for the purpose of adhesive-bonding to a glass pane of a motor vehicle, and having a passage opening to allow the passage of signals from/to a signaling device which is installed in the motor vehicle.

The invention relates to a flat electric heater element according to the preamble of Claim 1, in particular for heating a small region of a glass pane of a motor vehicle.

EP 1 281 574 B1 discloses a flat electric heater element for heating a mirror of a motor vehicle. Two current conductor layers and one electrical resistance layer are formed on a carrier film as the heater element. The resistance layer extends between the two current conductor layers and is in electric contact with both of them. The flat heater element has an unobstructed, light-diffusing area for the light of a signal indicator. The electrical resistance layer is composed of a material with a positive temperature coefficient (PTC). The electrical resistance of the said material is temperature-dependent. It increases as the temperature rises and decreases as the temperature falls.

The object of the invention is to provide a way of reducing the risk of signal transmission defects, which can be caused by snow, ice or condensation water, for electrical signaling devices, which communicate with external devices, in motor vehicles, even when only a small amount of installation space is available in the motor vehicle.

According to the invention, this object is achieved by a flat electric heater element according to Claim 1.

Further features of the invention can be found in the subclaims.

The invention particularly relates to the use of such a flat heater element for heating regions of glass panes of a motor vehicle.

The invention also relates to a motor vehicle which is provided with at least one such flat electric heater element.

The invention will be described below with reference to the drawings using preferred embodiments as examples. In the said drawings,

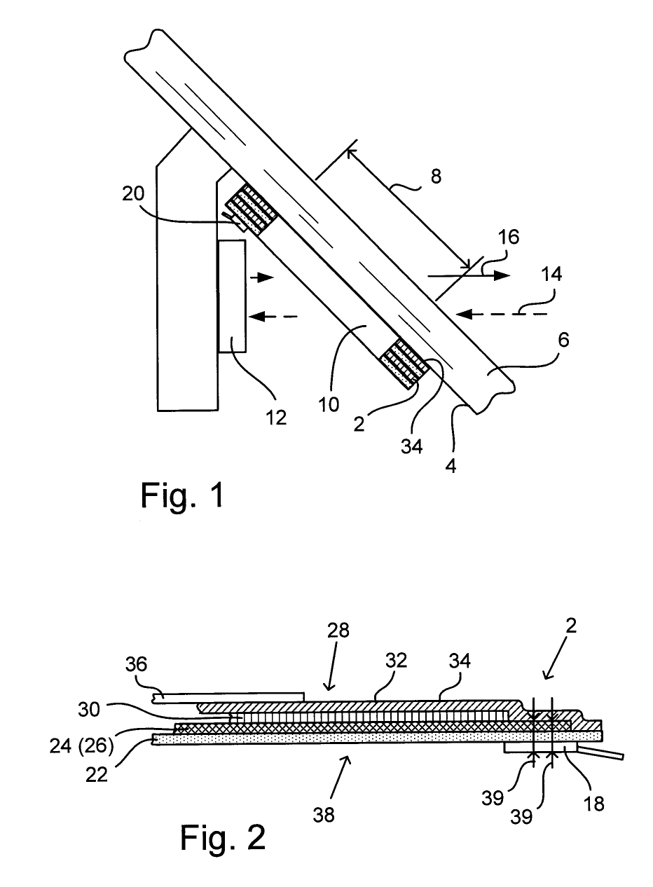

FIG. 1 shows a cross section through a glass pane of a motor vehicle, which glass pane may be a front windscreen or a rear windscreen of a passenger compartment of a vehicle, in combination with a flat electric heater element according to the invention which is adhesively bonded on the inner face of the glass pane, and in combination with a schematically illustrated signaling device,

FIG. 2 schematically shows a broken-away cross section through the flat heater element according to the invention,

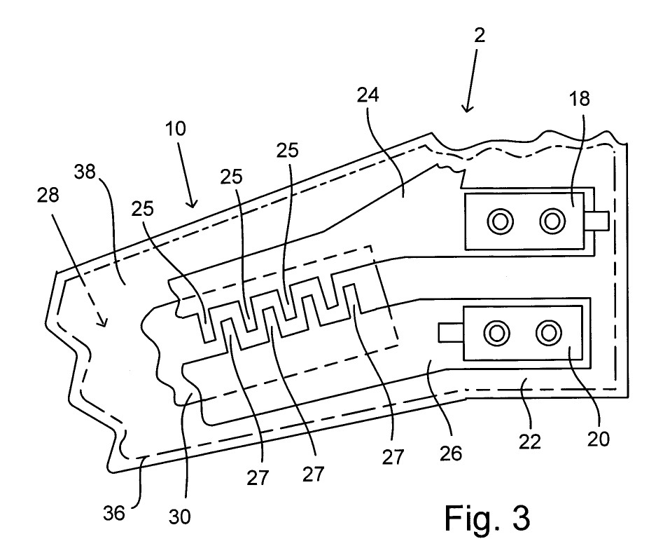

FIG. 3 shows a detail of the rear view (view from underneath FIG. 2) of the flat heater element according to the invention,

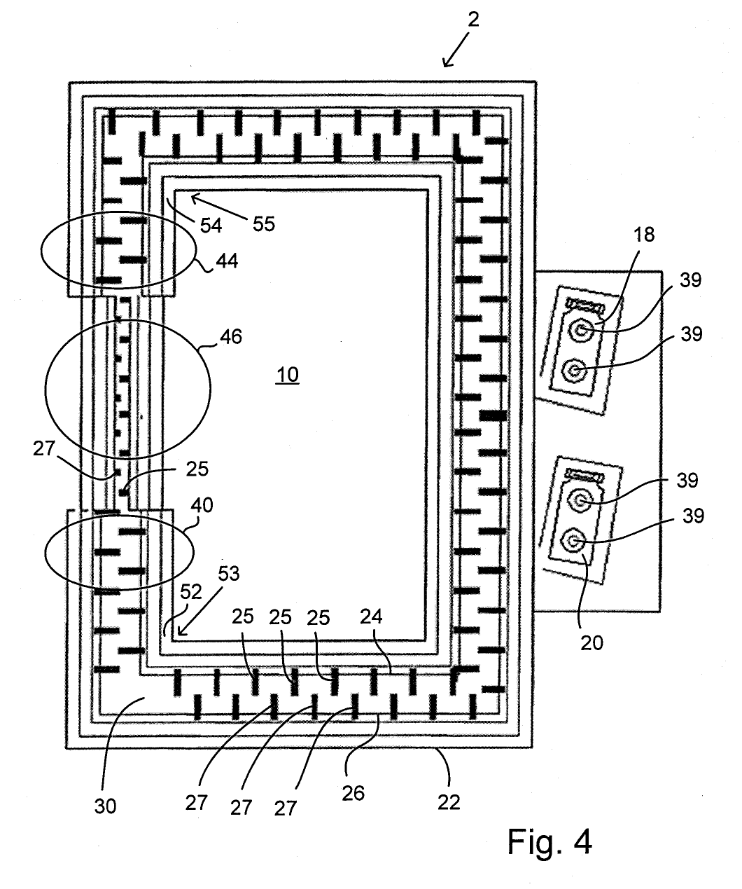

FIG. 4 shows a rear view of a preferred first embodiment of the flat heater element according to the invention,

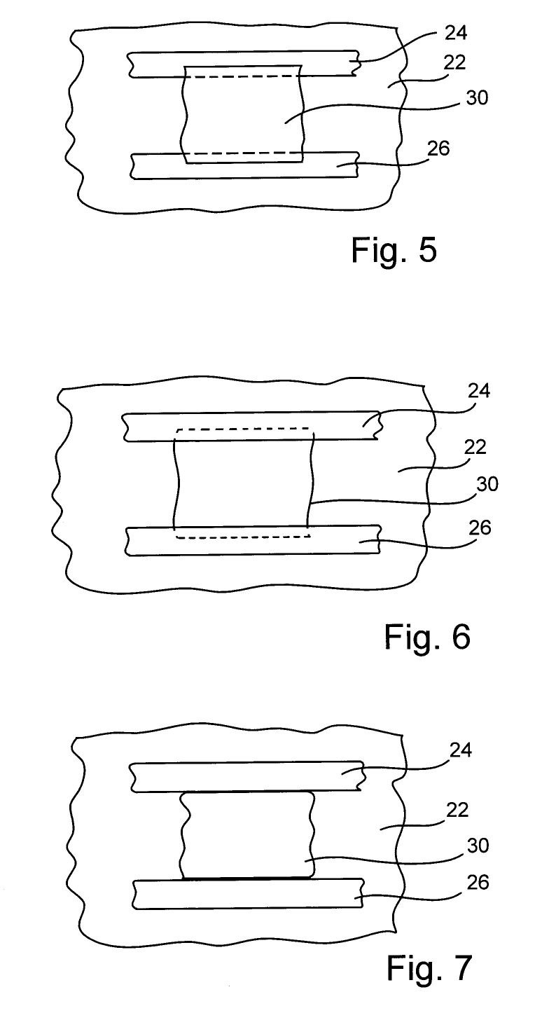

FIG. 5 shows a broken-away, enlarged front view of a detail of the flat heater element according to the invention,

FIG. 6 shows a broken-away, enlarged front view of a first variant according to the invention of the detail from FIG. 5,

FIG. 7 shows a broken-away, enlarged front view of a second variant according to the invention of the detail from FIG. 5.

FIG. 1 schematically shows a cross section through a flat electric heater element 2 according to the invention, which flat electric heater element is adhesively bonded to the inner face 4 of a glass pane 6 of a motor vehicle in order to heat a small region 8 of the glass pane, which region is opposite a passage opening 10 in the flat heater element and a signaling device 12 which is arranged in the motor vehicle (not illustrated). As a result, the signaling device 12 can receive signals 14 or transmit signals 16 through the passage opening 10 and the heated region 8 of the glass pane depending on whether the signaling device is a receiver, a transmitter or a transceiver. The flat heater element 2 is flexible.

The glass pane 6 is preferably a windscreen or a rear windscreen of the passenger compartment of a motor vehicle. However, the glass pane 4 may also be a side pane of a passenger compartment or a glass pane which is arranged outside the passenger compartment, for example in the engine compartment or beneath the rear boot space, in order to protect a signaling device 12, which is likewise arranged there, against dirt and water.

Heat which is generated by the flat heater element 2 in the region 8 of the glass pane prevents or clears condensation water and also melts and therefore likewise clears ice and snow. This ensures that the signals 14 and/or 16 can penetrate the region 8 of the glass pane without obstruction.

The sensor device 12 may take different forms, for example a device for generating a warning signal when the motor vehicle falls below a predetermined distance from the edge of the road (lane departure warning); a distance sensor in the form of a parking aid when parking the motor vehicle; a distance sensor for generating a warning signal and/or a vehicle deceleration signal in order to prevent an accident when the motor vehicle comes too close to an obstacle, for example a motor vehicle travelling in front or a stationary motor vehicle, at the normal driving speed; a camera or a film camera; a sensor for receiving signals relating to road-use charges (toll charges); a transmitter, for example for transmitting signals to receivers which register road charges for the motor vehicle; a transmitter for transmitting information signals to other motor vehicles; a transceiver which can perform both transmission and reception operations for the said or other purposes.

The received signals 14 and/or the transmitted signals 16 may be electromagnetic waves, radar signals or sonar signals, depending on the purpose of the signaling device 12.

The drawings show the flat electric heater element 2 with a greatly enlarged thickness for the purpose of illustrating the various details. In reality, the flat heater element 2 may be less than 1 mm thick, for example 0.3 mm. Only electric connection elements 18 and 20, if present, have a slightly greater thickness.

A preferred embodiment of a flat electric heater element 2 according to the invention is illustrated in FIGS. 1 to 4. The said flat electric heater element is a flexible body. It contains a carrier film 22 which is composed of opaque or preferably transparent plastic and extends around the passage opening 10; two current conductor layers 24 and 26 which are arranged on a first face 28 (front face) of the carrier film 22 and extend at a lateral distance from one another; an electrical resistance layer 30 as a heat conductor which generates heat, which electrical resistance layer is arranged on the same first film face 28 of the film and extends between the two current conductor layers 24 and 26 and is also in electric contact with the two current conductor layers 24 and 26, with the result that electric current can flow through the resistance layer 30 between the current conductor layers 24 and 26, substantially transverse to the latter. All of the layers 24, 26, 30 or individual layers 24, 26, 30 may be composed of transparent material. The electrical resistance layer 30 is preferably composed of a material which has a positive temperature coefficient (PTC), with the result that its electrical resistance value automatically increases as the temperature rises and decreases as the temperature falls. The two current conductor layers 24 and 26 preferably lie in the same layer plane.

The flat heater element 2 is in the form of a frame around the passage opening 10. The carrier film 22, the two current conductor layers 24 and 26 and the electrical resistance layer 30 extend around the passage opening 10 in the manner of a frame.

An adhesive layer 32, whose surface 34 which faces away from the carrier film 22 is self-adhesive for the purpose of adhesive-bonding to the glass pane 6, extends over the current conductor layers 24 and 26 and the electrical resistance layer 30.

As long as the flat heater element 2 is not adhesively bonded to the glass pane 6, the self-adhesive surface 34 is covered by a protective pull-off layer 36, for example made of paper or a plastic film.

FIGS. 3 and 4 are “perspective” illustrations of the flat heater element 2 as seen from its rear face, that is to say as if all of the layers are composed of transparent material. FIGS. 3 and 4 show the rear face, which is the second film face 38 of the flat heater element 2. In FIGS. 3 and 4, the carrier film 22 is the topmost layer, and the protective layer 36 is the lowermost layer.

According to FIG. 2 and FIG. 3, the two connection elements 18 and 20 are arranged on the second face 38 (rear face), which faces away from the first face 28 (front face), of the carrier film 22. The said connection elements are each electrically conductively connected to one of the two current conductor layers 24, 26 by electric conductors, preferably rivets 39, through the carrier film 22. The electric connection elements 18 and 20 are preferably in the form of plugging elements onto which mating plugging elements of electric conductors from a power source can be plugged.

Embodiments of the flat electric heater element 2 which do not have any connection elements 18 and 20, but in which end portions of the electric current conductor layers 24 and 26 are provided, onto which end portions power supply lines can be plugged or soldered, are also possible.

A further layer (not shown) which is composed of electrically insulating material may be located between the adhesive layer 32 on the one hand and the electrical resistance layer 30 and the current conductor layers 24 and 26 on the other hand.

The two current conductor layers 24 and 26 and the electrical resistance layer 30 are produced using a thin-film process or a thick-film process. A preferred process is the screen printing process. Furthermore, it is also possible to use photoelectric and chemical processes and also etching processes.

As shown in FIG. 4 in particular, at least one current conductor layer 24, for example the current conductor layer 24 which is radially on the inside in relation to the passage opening 10, is preferably a layer which extends continuously around the entire passage opening 10, and thus is an electric ring line. The other, radially outer current conductor layer 26 may also be in the form of a continuous ring line which extends around the entire passage opening 10. According to other embodiments (not shown) of the invention, one and/or the other of the two current conductor layers 24, 26 may have a finite length with two ends.

The current conductor layers 24 and 26 may have projections 25 and, respectively, 27 which in each case protrude away in the direction of the other current conductor in question in the form of a comb and are likewise in contact with the electrical resistance layer 30. Distribution of the heating power can be influenced by the size and positioning of these projections 25 and 27.

In this way and/or on account of different widths of the heater element 2 and the resistance layer 30, it is possible to distribute the heating power around the passage opening 10 in a predetermined manner in such a way that a homogeneous distribution of heat is produced very rapidly in the region 8 of the glass pane.

Furthermore, corner regions 52, 54 of the heater element 2 can be designed for a lower heating power than in adjacent regions of the flat heater element 2 as a result of such measures, in order to thus prevent more heat being generated in the glass pane 6 in the corners 53, 55 of the passage opening 10 than in the regions remote from the corners 53, 55.

As shown as an example in FIG. 4, the carrier film 22 of the flat heater element 2 has at least one or more regions 40, 42 with more electrical resistance material 30 for generating more heating heat (more heating energy) and, in each case adjacent to the said regions, at least one or more relatively narrower regions 46 with less resistance material 30 for generating less heating heat (less heating energy), in such a way that thermal compensation in the sense of a more homogeneous distribution of heat is produced in the region 8 of the glass pane which is to be heated. It is therefore possible to adapt the flat heater element 2 to the space conditions in the motor vehicle and thus to also advantageously use it when there is not enough space at certain points in the motor vehicle to design the flat heater element 2 to be of equal width throughout.

The terms “wider” and “narrower” relate to regions which are adjacent to one another, of which one region is relatively wide and the other region is narrower in relation to it.

FIGS. 5, 6 and 7 are front views of the flat heater element 2 as seen on the first film face 28. They show different variants of the flat heater element 2.

According to the variant of FIG. 5, first the two current conductor layers 24 and 26 and then the electrical resistance layer 30 (heat conductor) are applied to the carrier film 22, with the electrical resistance layer 30 at least partially overlapping the two current conductor layers 24 and 26 and thus being in good electrical contact with them.

According to the variant of FIG. 6, first the electrical resistance layer 30 has been applied to the carrier film 22 and then the two current conductor layers 24 and 26 have been applied to the carrier film 22. In this embodiment too, the current conductor layers 24 and 26 each at least partially overlap the resistance layer 30, with the result that they are in good electrical contact with it.

FIG. 7 shows a variant in which the two current conductor layers 24 and 26 are applied to the carrier film 22 in such a way that they do not overlap the electrical resistance layer 30 which is likewise applied to the carrier film 22, but only touch the edge of the said electrical resistance layer. The variants according to FIGS. 5 and 6 are more functionally reliable than the variant according to FIG. 7.

In place of a single passage opening 10, a flat electric heater element according to the invention may also have two or more passage openings 10 around which the flat heater element 2 and its current conductor layers 24 and 26 and the electrical resistance layer 30 extend.

1. Flat electric heater element, which is flexible, comprising a carrier film; two current conductor layers which are arranged on a first face of the carrier film and extend at a lateral distance from one another; an electrical resistance layer in the form of a heat conductor, which electrical resistance layer is arranged on the same first film face, extends between the two current conductor layers and is in electrically conductive contact with the two current conductor layers, with the result that electric current can flow through the electrical resistance layer between the current conductor layers; an adhesive layer, which is composed of electrically insulating material, over the electrical resistance layer and over the current conductor layers, which adhesive layer has a self-adhesive surface for adhesively bonding the flat heater element to an element which is to be heated and is composed of thermally conductive material; characterized in that the whole flat heater element is in the form of a frame around at least one passage opening, with the carrier film, the current conductor layers and the electrical resistance layer extending around the passage opening in the manner of a frame; in that the carrier film has at least one relatively wide region with more resistance material for generating more heating heat and, adjacent to this, at least one relatively narrow region with less resistance material for generating less heating heat, in such a way that thermal compensation in the sense of a more homogeneous distribution of heat, in the region of the passage opening is produced in the element which is to be heated and is composed of thermally conductive material.

2. Flat electric heater element according to claim 1, characterized in that the electrical resistance layer is composed of a material which has a positive temperature coefficient and whose electrical resistance increases as the temperature rises and decreases as the temperature falls.

3. Flat electric heater element according to claim 1, characterized in that the at least one layer, preferably each of the said layers, is a layer which is produced using the thin-film technique or using the thick-film technique, preferably using the screen printing technique.

4. Flat electric heater element according to claim 1, characterized in that at least one of the two current conductor layers is a continuous ring line which extends around the entire, at least one passage opening.

5. Flat electric heater element according to one of the preceding claim 1, characterized by electric connection elements on the second face of the carrier film which faces away from the first film face, with the connection elements being electrically conductively connected to the electric current conductor tracks.

6. Flat electric heater element according to claim 1, characterized by a protective pull-off layer on the self-adhesive surface of the adhesive layer.

7. Use of a flat electric heater element according to claim 1 for the purpose of adhesive-bonding onto the inner face of a glass pane of a motor vehicle in order to heat a small region of the glass pane, which region is opposite the passage opening in the flat heater element and a signaling device which is arranged in the motor vehicle, with the result that the signaling device can receive or transmit signals through the passage opening and the heated region of the glass pane, with the signaling device being a receiver, a transmitter or a transceiver.

8. Motor vehicle, characterized by a flat electric heater element according to claim 1, with the flat heater element being adhesively bonded on the inside of a glass pane of the motor vehicle in order to heat a small region of the glass face, which region is opposite the passage opening in the flat heater element and a signaling device which is arranged in the motor vehicle, with the result that the signaling device can receive or transmit signals through the passage opening and the heated region of the glass pane, with the signaling device being a receiver, a transmitter or a transceiver.
